(19) United States
(12) Patent Application Publication
(10) Pub. No.: US 2009/0011181 A1
(43) Pub. Date: Jan. 8, 2009

(54) HONEYCOMB STRUCTURE BODY COMPOSED OF A PLURALITY OF HEXAGONAL CELLS

(76) Inventors: Tatsuji MIZUNO, Nagoya-shi (JP); Toshiharu Kondo, Toyoake-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/209,347

(22) Filed: Sep. 12, 2008

Related U.S. Application Data
(63) Continuation of application No. PCT/JP2007/055941, filed on Mar. 15, 2007.

(30) Foreign Application Priority Data
Mar. 15, 2006 (JP) 2006-071078

(51) Int. Cl. B32B 3/12

(52) U.S. Cl. 428/118

(57) ABSTRACT

A honeycomb structure body is composed of hexagonal cells and an outer peripheral wall. Each hexagonal cell is surrounded by six cell walls of a hexagonal arrangement. The cell walls are divided into standard cell walls and reinforced cell walls. The strength of each reinforced cell wall is stronger than that of each standard cell wall. The reinforced cell walls form a strength reinforced area. Each component in the strength reinforced area has an approximate straight-line shape observed on a cross section in the diameter direction of the honeycomb structure body. Both ends of each component in the strength reinforced area are contacted to the outer peripheral wall.

This is a continuation of PCT application PCT/JP2007/055941 filed Mar. 15, 2007, which in turn is based on Japanese application 2006-071078 filed Mar. 15, 2006, the entire contents of each of which is incorporated herein by reference.

### TECHNICAL FIELD

The present invention relates to a honeycomb structure body composed of a plurality of hexagonal cells arranged in a honeycomb structure configuration and each hexagonal cell is surrounded by a hexagonal-configuration cell wall composed of six sides.

### BACKGROUND ART

A honeycomb structure body has been well and widely known as exhaust gas purifying base material for vehicles. Such a honeycomb structure body is made mainly of ceramics materials of a highly thermal shock resistance capability. The honeycomb structure body is composed mainly of an outer peripheral wall (or a surrounding wall) of a cylindrical-shaped outline and a plurality of hexagonal-configuration cells (hereinafter, referred to as “hexagonal cells for short) arranged in a lattice configuration in which each cell is surrounded by six cell walls. In the honeycomb structure body, catalyst material is supported on the surface of each hexagonal cell arranged in a lattice configuration.

There are various configurations or shapes of a cell forming a honeycomb structure body such as a triangle shape, a square shape and a hexagonal shape. In general, the honeycomb structure body composed of plural hexagonal cells is capable of reducing a pressure loss because of enabling the hexagonal cells to support a catalyst on the cell walls with a uniform thickness when compared with other honeycomb structure bodies having plural triangle-configuration cells or square-configuration cells. Still further, because the configuration of the honeycomb structure body composed of plural hexagonal cells is capable of reducing the entire weight because of suppressing an excess amount of catalyst. In particular, the honeycomb structure body composed of the plural hexagonal cells has become of major interest recently considering from such a feature and capability.

However, such a honeycomb structure body of a superior exhaust gas purifying performance involves a drawback of being a low isostatic strength when compared with that of the honeycomb structure body having another-configuration cells, in particular, having triangle-configuration cells or square-configuration cells. In use of the exhaust gas purifying base material for vehicles, the honeycomb structure body of weak isostatic strength is easily broken by vibration and shock generated during canning process for an exhaust gas pipe or during an assembling process to a vehicle.

In order to avoid or solve the above drawbacks, there is a conventional technique of increasing the isostatic strength of the honeycomb structure body having plural hexagonal cells. For example, Japanese patent laid open publication No. JP S55-155741 has disclosed such a conventional technique of increasing a thickness of a cell wall within a specified distance measured from an outer peripheral wall. However, such a configuration of the above conventional technique of having the improved thickness of cell walls increases the pressure loss and reduces a prompt warming performance of warming up catalyst supported on the cell walls (as “the catalyst prompt warming performance”). Accordingly, such a conventional technique, for example, disclosed by JP S55-155741, has caused a possibility of deteriorating the entire exhaust gas purifying performance of the honeycomb structure body composed of plural hexagonal cells

There are various other conventional techniques of increasing the isostatic strength of the honeycomb structure body composed of plural hexagonal cells. For example, Japanese patent laid open publications JP H11-270334 and JP H11-277653) have disclosed a manner of changing the thickness of each cell wall or an outer peripheral wall within a specified area in a honeycomb structure body, or Japanese patent laid open publications JP 2002-46117 has disclosed a manner of setting within a specified range the radius of curvature at the intersection of cell walls and at the intersection of a cell wall and an outer peripheral wall in a honeycomb structure body.

Further, there is another conventional technique of changing the shape of cells located at the outer peripheral part of a honeycomb structure body and a manner of forming a reinforced rib to cells located at the outer peripheral part of the honeycomb structure body disclosed in Japanese patent laid open publication No, JP H11-270334.

Still further, there is another conventional technique of sealing cells located at a specified area of the outer peripheral part in a honeycomb structure body by sealing members as disclosed in Japanese patent laid open publication No. JP 2004-154768. However, those conventional techniques and manners described above cannot satisfy the condition of increasing both of the strength and performance (for example, exhaust gas purifying performance), simultaneously. Accordingly, it is in greatest demand for the exhaust gas purifying technology field to provide a honeycomb structure body composed of plural hexagonal cells with superior isostatic strength while maintaining or keeping, without deteriorating, a superior exhaust gas purifying performance.

### DISCLOSURE OF THE INVENTION

It is an object of the present invention to provide a honeycomb structure body composed of a plurality of hexagonal cells arranged in a honeycomb structure configuration with increased and improved isostatic strength while maintaining, without decreasing, its exhaust gas purifying performance.

In accordance with an aspect of the present invention, there is provided a honeycomb structure body composed mainly of an outer peripheral wall and a plurality of hexagonal cells. The outer peripheral wall covers an outer peripheral surface of the honeycomb structure body. A plurality of the hexagonal cells is formed in a honeycomb structure configuration inside the outer peripheral wall. Each hexagonal cell is surrounded by cell walls placed in a hexagonal arrangement. In the honeycomb structure body, the cell walls forming the hexagonal cells are composed of standard cell walls and reinforced cell walls. The strength of the reinforced cell walls is stronger than that of the standard cell walls. The reinforced cell walls form a strength reinforced area of an approximate straight-line shape observed on a cross section in the diameter direction of the honeycomb structure body. Both ends of the strength reinforced area are contacted to the outer peripheral wall.

The honeycomb structure body composed of the plural hexagonal cells according to the present invention has the strength reinforced area that is composed of the reinforced cell walls. The strength of the strength reinforced area is higher than that of the standard cell walls. The strength reinforced area is formed in approximate straight-line shape observed on a cross-section in the diameter direction of the honeycomb structure body. Both ends of the strength reinforced area are contacted to the outer peripheral wall of the honeycomb structure body. That is, the strength reinforced area composed of the high-strength reinforced cell walls joints or links optional two points on the outer peripheral wall of the honeycomb structure body. The strength reinforced area acts as a beam or rib for the outer peripheral wall when a stress is applied to the outer peripheral wall, that is, the strength reinforced area can disperse and relax the stress applied to the outer peripheral wall in the honeycomb structure body. It is thereby possible to provide the honeycomb structure body composed of the plural hexagonal cells with increased stronger strength.

Further, the strength reinforced area is placed in approximate straight-line shape when observed from the cross-section of the honeycomb structure body according to the present invention. That is, the reinforced cell walls forming the strength reinforced area are not formed in the entire area or a specified large area in the honeycomb structure body, but are formed only in a small-sized area of the approximate straight-line shape. This configuration and feature can increase the isostatic strength of the honeycomb structure body composed of a plurality of the hexagonal cells. In the use of the above configuration of adding the strength reinforced area to a honeycomb structure body, the occurrence of increasing a pressure loss or deteriorating a catalyst prompt warming performance of the strength reinforced area only provides a small influence to the exhaust gas purifying performance in the entire area of the honeycomb structure body. This configuration and feature means that the honeycomb structure body composed of a plurality of the hexagonal cells can adequately maintain its exhaust gas purifying performance.

As described above, the honeycomb structure body of the present invention is capable of having the improved and increased isostatic strength while maintaining, namely, without deteriorating, the exhaust gas purifying performance because of incorporating the strength reinforced area therein.

In the honeycomb structure body of the present invention, the cross-section in the diameter direction means a cross-section orthogonal to the axis direction of the honeycomb structure body.

It is preferred that the strength reinforced area is composed of plural components and each part has an approximate straight line shape. This configuration can further increase the isostatic strength of the honeycomb structure body.

It is further preferred to place the components forming the strength reinforced area in a point-symmetry around the center point of the cross section in the diameter direction of the hexagonal structure body. This configuration can effectively increase the entire isostatic strength of the honeycomb structure body having a plurality of the hexagonal cells in well-balanced condition.

It is still further preferred that the strength reinforced area is formed passing through the center point of the cross-section in the diameter direction of the honeycomb structure body. This configuration can adequately and certainly increase the isostatic strength of the honeycomb structure body composed of the plural hexagonal cells.

It is preferred that at least some components of the strength reinforced area form a polygon on a cross section in the diameter direction of the honeycomb structure body and the polygon is inscribed in the outer peripheral wall. This configuration provides that the components of the strength reinforced area act as beams against the entire area of the outer peripheral wall. It is thereby possible to entirely and adequately increase the isostatic strength of the honeycomb structure body in well-balanced condition.

It is still further preferred that a thickness of each reinforced cell wall forming the strength reinforced area is larger than that of each standard cell wall. This configuration certainly increases the strength of the strength reinforced area including the reinforced cells rather than that of the area including the standard cells.

It is preferred that the thickness of the reinforced cell wall is within a range of 1.3 times to 1.8 times of the thickness of the standard cell wall.

When the thickness of the reinforced cell wall is less than 1.3 times of the thickness of the standard cell wall, there is a possibility of not adequately increase the strength of the strength reinforced area. On the contrary, when exceeds 1.8 times, there is a possibility of increasing the pressure-loss of the strength reinforced area because of increasing the thickness of each reinforced cell wall. According to the increase of the weight of the reinforced cell walls, there is a 0possibility of deteriorating the catalyst prompt warming performance of the honeycomb structure body, and thereby of deteriorating the exhaust gas purifying performance of the entire of the honeycomb structure body composed of the plural hexagonal cells.

It is still further preferred that each hexagonal cell has six interior angle parts formed by the cell walls and three interior angle parts surrounding each of intersections between the reinforced cell walls adjacent to each other are R-angle parts of an approximate circular shape. In other words, with regard to one hexagonal cell formed by surrounded with the reinforced cell walls, there are four interior angle parts formed at the intersections between the reinforced cell walls adjacent to each other in the six interior angle parts, and these four interior angle parts are R-angle parts of an approximate circular shape.

Because of enabling this configuration to increase the strength of the reinforced cell walls, it is possible to adequately and certainly increase the entire strength of the strength reinforced area composed of the reinforced cell walls continuously connected when compared with the area composed of the standard cell walls.

It is still further preferred that three interior angle parts surrounding each of intersections between the reinforced cell walls and the standard cell wall adjacent to each other are R-angle parts of an approximate circular shape. In other words, with regard to one hexagonal cell formed by surrounded with the reinforced cell walls, there are two interior angle parts formed at the intersections between the reinforced cell walls and the standard cell wall adjacent to each other in the six interior angle parts, and these two interior angle parts are R-angle parts of an approximate circular shape. Namely, all of the six interior angle parts 23 are R-angle parts 231.

Because of enabling this configuration to increase the strength of the reinforced cell walls, it is possible to further increase the strength of the strength reinforced area.

It is preferred that the radius of curvature of the R-angle part is 0.15 to 0.4 mm and the radius of curvature of the R-angle part is 0.2 mm to 0.35 mm. When the radius of curvature of the R-angle part is less than 0.15 mm, there is a possibility to not adequately increase the strength of the reinforced cell walls. This configuration introduces a possibility of not adequately increase the strength of the strength reinforced area. On the other hand, when it exceeds 0.4 mm, because of increasing the thickness of the cell walls at the R-angle part, there is a possibility of increasing the pressure-loss of the strength reinforced area. According to the increase of the weight of the reinforced cell walls, there is a possibility of deteriorating the catalyst prompt warming performance of the honeycomb structure body, and thereby of deteriorating the exhaust gas purifying performance of the entire area of the honeycomb structure body composed of the plural hexagonal cells. Accordingly, it is more preferred that the radius of curvature of the R-angle part takes the range of 0.2 mm to 0.35 mm.

It is preferred that the maximum width of the strength reinforced area is within a range of 1.0 mm to 5.0 mm. When the maximum width of the strength reinforced area is less than 1.0 mm, there is a possibility that each part of the strength reinforced area does not adequately acts as a beam against the outer peripheral wall of the honeycomb structure body. This configuration causes a possibility of not adequately increasing the isostatic strength of the honeycomb structure body. On the other hand, when it exceeds 5.0 mm, there is a possibility of enabling this configuration to increase the pressure-loss and of deteriorating the catalyst prompt warming performance of the honeycomb structure body when the strength of the reinforced cell walls is increased by increasing the thickness of the cell walls, for example. The maximum width of the strength reinforced area is the maximum width of the area including the reinforced cell walls observed on a cross-section in the diameter direction of the honeycomb structure body.

It is preferred that the thickness of the outer peripheral wall is within a range of 0.2 mm to 0.6 mm. When the thickness of the outer peripheral wall is less than 0.2 mm, there is a possibility of adequately maintaining the strength of the outer peripheral wall itself and thereby of deteriorating the isostatic strength of the honeycomb structure body composed of the plural hexagonal cells and of causing a nick or break on the honeycomb structure body while transmission. On the other hand, when it exceeds 0.6 mm, because of enabling this configuration to increase the temperature difference between the outside and the inside of the outer peripheral wall, it is a possibility of deteriorating the thermal shock resistance capability of the honeycomb structure body.

It is still further preferred that a thickness of each standard cell wall is within a range of 50 μm to 125 μm. When the thickness of the standard cell wall is less than 50 μm, there is a possibility of adequately maintaining the strength of the standard cell wall itself and thereby of deteriorating the isostatic strength of the honeycomb structure body composed of the plural hexagonal cells. On the other hand, when it exceeds 125 μmm, there is a possibility of increasing the pressure-loss of the honeycomb structure body composed of the hexagonal cells. There is further a possibility of deteriorating the catalyst prompt warming performance of the honeycomb structure body according to the increase of the weight of the standard cell walls. That is, there is a possibility of deteriorating the exhaust gas purifying capability of the entire of the honeycomb structure body by the above-described deteriorations in the quality thereof.

### BRIEF DESCRIPTION OF THE DRAWINGS

FIG. 1 is a perspective view showing the entire configuration of a ceramic honeycomb structure body composed of a plurality of hexagonal cells according to a first embodiment of the present invention.

FIG. 2 is a cross-sectional view showing reinforced cell walls and standard cell walls in the ceramic honeycomb structure body according to the first embodiment shown in FIG. 1.

FIG. 3 is a cross-sectional view showing a part of the ceramic honeycomb structure body observed from its radial direction according to the first embodiment shown in FIG. 1.

FIG. 4 is a view showing an arrangement of the reinforced cell walls placed in the strength reinforced area formed in the honeycomb structure body according to the first embodiment.

FIG. 5 is a graph showing the measurement results of isostatic strength of the cell walls in the ceramic honeycomb structure body of the first embodiment and a ceramic honeycomb structure body of a related art.

FIG. 6 is a cross-sectional view showing the reinforced cell walls and the standard cell walls that form a ceramic honeycomb structure body according to a second embodiment of the present invention.

FIG. 7 is a cross-sectional view showing the reinforced cell walls and the standard cell walls that form a ceramic honeycomb structure body according to a third embodiment of the present invention.

FIG. 8 is a cross-sectional view showing a part of a ceramic honeycomb structure body in its radial direction according to a fourth embodiment of the present invention, in particular, showing an arrangement of hexagonal cells placed in the strength reinforced area.

FIG. 9 is a view showing an arrangement of the components forming the strength reinforced area in the honeycomb structure body according to the fourth embodiment.

FIG. 10 is a view showing another arrangement of the components forming the strength reinforced area in the honeycomb structure body according to the fourth embodiment.

FIG. 11 is a view showing another arrangement of the components forming the strength reinforced area in the honeycomb structure body according to the fourth embodiment.

FIG. 12 is a view showing another arrangement of the components forming strength reinforced area in the honeycomb structure body according to the fourth embodiment.

### BEST MODES FOR CARRYING OUT THE INVENTION

Hereinafter, various embodiments of the present invention will be described with reference to the accompanying drawings. In the following description of the various embodiments, like reference characters or numerals designate like or equivalent component parts throughout the several diagrams.

### First Embodiment

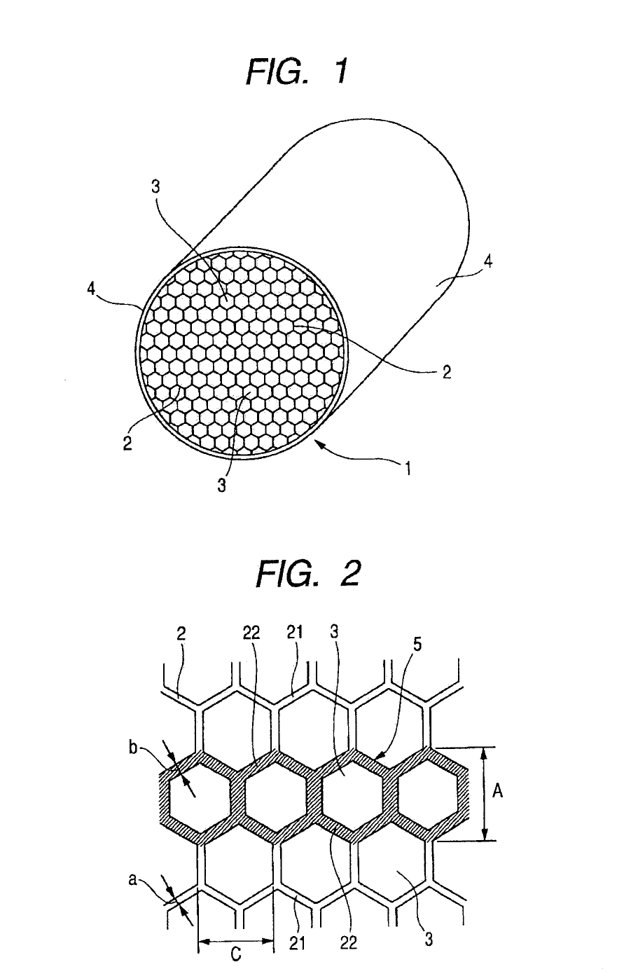

A description will be given of the honeycomb structure body composed of a plurality of hexagonal-configuration cells (hereinafter, referred to as “the hexagonal cells” for short) arranged in a honeycomb structure configuration according to the first embodiment of the present invention with reference to FIG. 1 to FIG. 5.

FIG. 1 is a perspective view showing the entire configuration of the ceramic honeycomb structure body 1 that is composed of a plurality of the hexagonal cells 3. Those hexagonal cells 3 are arranged in a honeycomb structure configuration.

FIG. 2 is a cross-sectional view showing reinforced cell walls and standard cell walls which are arranged in a honeycomb structure configuration in the ceramic honeycomb structure body 1 shown in FIG. 1.

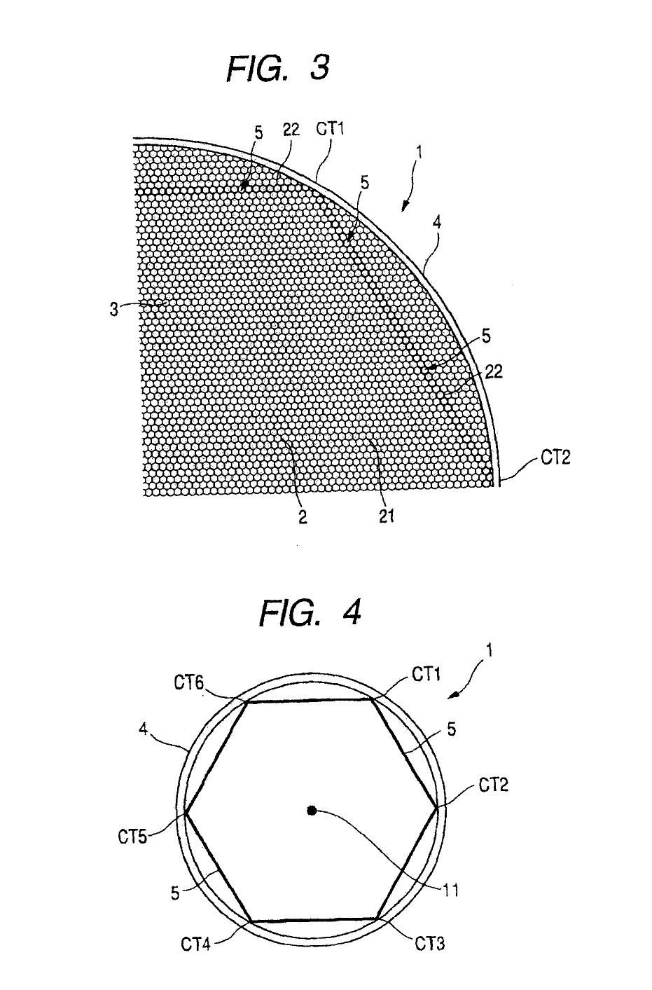

FIG. 3 is a cross-sectional view showing a part of the ceramic honeycomb structure body 1 observed along a radial direction. FIG. 4 is a view showing an arrangement of the reinforced cell walls placed in a strength reinforced area in the honeycomb structure body 1 shown in FIG. 1.

As shown in FIG. 1 to FIG. 4, the honeycomb structure body 1 according to the first embodiment has a plurality of the hexagonal cells 3 and an outer peripheral wall 4 (or a surrounding wall 4) of a cylindrical shape. Each hexagonal cell 3 is surrounded by six cell walls 2 arranged in a hexagonal shape. The honeycomb structure body 1 has standard cell walls 21 and reinforced cell walls 22. The isostatic strength of the reinforced cell wall 22 is higher than that of the standard cell wall 21. As shown in FIG. 3, the reinforced cell walls 22 are formed in a strength reinforced area 5 in the honeycomb structure body 1. FIG. 3 shows a part of the strength reinforced area 5 including the reinforced cell walls 22 observed on a cross-sectional area in the diameter direction of the honeycomb structure body 1. FIG. 4 shows the strength reinforced area 5 composed of six components, observed on the cross-sectional area in the diameter direction of the honeycomb structure body 1. Each component of the strength reinforced area 5 has an approximate straight-line shape and the both ends of the component having the straight-line shape are contacted at points CT1 to CT6 (see FIG. 3 and FIG. 4, hereinafter, referred to as “the contact points CT1 to CT6”) in the outer peripheral wall 4 of the honeycomb structure body 1.

A description will be given of the strength reinforced area 5 in which the reinforced cell walls 22 are formed in the honeycomb structure body 1.

As shown in FIG. 1, the honeycomb structure body 1 composed of the hexagonal cells is applied to a vehicle exhaust gas purifying base material and made mainly of cordierite ceramic material. The honeycomb structure body 1 has the outer diameter of 103.0 mm and the length of 130.0 mm. The outer peripheral surface of the honeycomb structure body 1 is surrounded by the outer peripheral wall 4. A plurality of the hexagonal cells 3 are formed in the inside of the outer peripheral wall 4. Each hexagonal cell 3 is surrounded by the six lattice-shaped cell walls forming each cell wall 2. The thickness of the outer peripheral wall 4 is 0.4 mm.

Further, as shown in FIG. 2, the cell wall 2 in the honeycomb structure body 1 of the first embodiment is divided into two types, the standard cell walls 21 and the reinforced cell walls 22. The thickness of the reinforced cell wall 22 is larger than that of the standard cell wall 21, and the isostatic strength of the reinforced cell wall 22 is stronger than that of the standard cell wall 21.

In the first embodiment, the thickness “a” (see FIG. 2) of the standard cell wall 21 is 90 μm, and the thickness “b” (see FIG. 2) of the reinforced cell wall 22 is 117 μm. Therefore, the thickness of the reinforced cell wall 22 is 1.3 times of that of the standard cell wall 21. The pitch “C” of the cell walls (see FIG. 2, hereinafter, referred to as “the cell pitch “C”) in the honeycomb structure body 1 is 1.11 mm.

As clearly observed on a cross-sectional area in the diameter direction of the honeycomb structure body 1 shown in FIG. 2, the honeycomb structure body 1 has the strength reinforced area 5 in which the reinforced cell walls 22 are formed. The strength reinforced area 5 including the reinforced cell walls 22 is greatly stronger in strength than that of the area in which the standard cell walls 21 are formed. The maximum width “A” of the strength reinforced area 5 is 1.42 mm. The cross-section in the diameter direction of the honeycomb structure body 1 according to the first embodiment is a cross-section orthogonal to the axis direction of the honeycomb structure body 1. The maximum width A of the strength reinforced area 5 is the maximum width in the area where the reinforced cell walls 22 are formed.

In addition, as shown in FIG. 3 and FIG. 4, the strength reinforced area 5 is composed of the six components, observed from the cross-section in the diameter direction, through the entire of the honeycomb structure body 1. Each of the six components forming the strength reinforced area 5 has approximately a straight line shape. Both ends of each component forming the strength reinforced area 5 are contacted to the outer peripheral wall 4. That is, both ends of each component of the strength reinforced area 5 are contacted between optional two points on the outer peripheral wall 4.

As clearly shown in FIG. 3 and FIG. 4, the strength reinforced area 5 composed of the six components is a polygon inscribed in the outer peripheral wall 4 of the honeycomb structure body 1. In other wards, the strength reinforced area 5 is a hexagon which is inscribed in the outer peripheral wall 4 and placed in a point-symmetry about the center point 11 of the cross-section in the diameter direction of the honeycomb structure body 1.

FIG. 4 only shows the outer peripheral wall 4, the strength reinforced area 5 and the center point 11 in order to clearly show the arrangement of the six components in the strength reinforced area 5 observed from the cross-section in the diameter direction of the honeycomb structure body 1 according to the first embodiment.

Next, a description will be given of the manufacturing process of the honeycomb structure body 1 according to the first embodiment of the present invention.

The honeycomb structure body 1 according to the first embodiment of the present invention can be manufacturing by a conventional manufacturing process widely known. That is, an extrusion molding makes a honeycomb molded body by using cordierite as a ceramic raw material, for example, composed mainly of kaolin, fused silica, and aluminum hydroxide, alumina, talc, and carbon particles and the like mixed in optimum proportions. The honeycomb molded body is cut into plural honeycomb shaped bodies. Each honeycomb shaped boy has a specified length. The honeycomb shaped body is dried and fired in order to obtain the honeycomb structure body 1. In particular, an extrusion molding die is used in the extrusion molding process. The shape of the extrusion molding die has plural slit-grooves that correspond to the arrangement of the reinforced cell walls 22 and the standard cell walls 21 in the honeycomb structure body 1 of the first embodiment. Those slit-grooves can be formed by available manners such as electric discharge machining or laser beam machining widely known.

### (Results of Measurement)

A description will be given of the measurement results according to the isostatic strength of the honeycomb structure body 1 composed of the plural hexagonal cells according to the first embodiment of the present invention.

Two types of samples E1 and C1 of different isostatic strengths have been prepared in the measurement. Sample E1 is the honeycomb structure body 1 according to the first embodiment of the present invention. Sample C1 is a comparison sample such as a honeycomb structure body of a related art composed of hexagonal cells as a configuration composed only of the standard cell walls 21 without the reinforced cell walls 22 and the strength reinforced area 5.

In the preparation of the samples E1 and C1 for the measurement of the isostatic strength, aluminum plates were contacted to both end surfaces of the honeycomb structure body (as each sample E1 and C1), the entire of the outer periphery of the honeycomb structure body was covered with a rubber tube, and both ends of the tube were sealed with tape. Samples E1 and C1 were placed in a hydraulic pressure container and water was gradually supplied into the hydraulic pressure container in order to increase the hydraulic pressure in the container. The isostatic strength of each sample was determined when the sample in the hydraulic pressure vessel was broken by the hydraulic pressure.

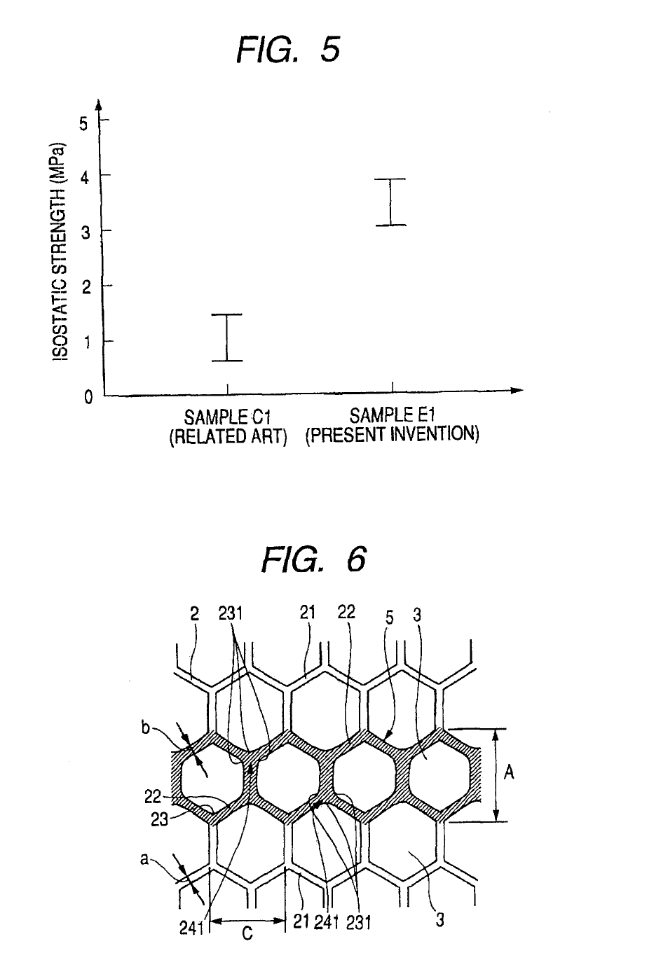

FIG. 5 shows the results of the measurement of the isostatic strength of the samples E1 and C1. As clearly understood from the result of the measurement shown in FIG. 5, sample C1 as the honeycomb structure body of the related art has the isostatic strength of approximately 1 MPa, and on the contrary, sample E1 as the honeycomb structure body 1 of the first embodiment has the isostatic strength of approximately 3.5 MPa. That is, the isostatic strength of the honeycomb structure body 1 (sample E1) according to the present invention is approximately three times of that of the honeycomb structure body of the related art (sample C1).

Next, a description will be given of the explanation of the action and effect of the honeycomb structure body 1 according to the first embodiment of the present invention.

In the honeycomb structure body 1 of the first embodiment, the strength reinforced area 5 composed of the plural components, namely, the six components shown in FIG. 4. Each component in the strength reinforced area 5 is composed of the reinforced cell walls 22, and the thickness and strength of each reinforced cell wall 22 are greater than those of each standard cell wall 21. Both ends of each component of the strength reinforced area 5 are contacted at optional two points on the outer peripheral wall 4 of the honeycomb structure body 1. That is, when a stress is applied to the outer peripheral wall 4 in the honeycomb structure body 1, each component forming the strength reinforced area 5 acts as a beam forming the outer peripheral wall 4 of the honeycomb structure body 1, and in other words, the strength reinforced area 5 is capable of dispersing and releasing the stress applied from the outside of the honeycomb structure body 1. This ability of the honeycomb structure body 1 according to the first embodiment has an improved highly isostatic strength when compared with the honeycomb structure body of the related art.

In addition, each part of the strength reinforced area 5 has an approximate straight line shape placed in the honeycomb structure body 1. That is, the reinforced cell wall 22 forming each part of the strength reinforced area 5 are formed only in a small area of the approximate straight-line shape in the honeycomb structure body 1. This configuration of the reinforced cell wall 22 can increase the isostatic strength of the honeycomb structure body 1 of the first embodiment. Accordingly, even if the pressure loss is increased and the catalyst prompt warming performance is deteriorated in the strength reinforced area 5, the configuration of the reinforced cell wall 22 in the honeycomb structure body 1 gives an extremely less influence to the entire of the exhaust gas purifying performance occurs. This configuration can adequately maintain the exhaust gas purifying performance of the honeycomb structure body 1 of the first embodiment.

Still further, according to the first embodiment of the present invention, the six components forming the strength reinforced area 5 are placed in a point-symmetry to the center point 11 of the cross-section along the diameter direction of the honeycomb structure body 1.

This configuration can efficiently increase the isostatic strength of the honeycomb structure body 1 in a well-balanced condition.

Furthermore, the strength reinforced area 5 has a polygon, when observed on a cross-section in the diameter direction, which is inscribed in the outer peripheral wall 4 of the honeycomb structure body 1 of the first embodiment. Accordingly, the strength reinforced area 5 acts as the beams to the entire of the outer peripheral wall 4, and can thereby increase the isostatic strength of the honeycomb structure body 1 in the entirely well-balanced condition.

The configuration of the first embodiment enables the honeycomb structure body 1 to increase the isostatic strength thereof while maintaining, without decreasing, the exhaust gas purifying performance.

### Second Embodiment

A description will be given of the honeycomb structure body composed of plural hexagonal cells according to the second embodiment of the present invention with reference to FIG. 6.

FIG. 6 shows a cross-section of the honeycomb structure body composed of the standard cell walls 21 and the reinforced cell walls 22 according to the second embodiment of the present invention.

In the honeycomb structure body of the second embodiment shown in FIG. 6, each hexagonal cell 3 has six interior angle parts 23 made by the cell walls 2. In particular, a R-angle part 231 of approximate circular-arc shape is formed at each of three interior angle parts 23 surrounding the reinforced intersections 241 between the adjacent three reinforced cell walls 22.

In other words, with regard to one hexagonal cell 3 formed by surrounded with the reinforced cell walls 22, there are four interior angle parts 23 formed at the reinforced intersections 241 between the reinforced cell walls 22 adjacent to each other in the six interior angle parts 23, and these four interior angle parts 23 are R-angle parts 231 of an approximate circular shape. And then, with regard to one reinforced intersection 241, three interior angle parts 23 of three hexagonal cells 3 surrounding the one reinforced intersection 241 are R-angle parts 231 of an approximate circular shape.

In the configuration of the second embodiment, the thickness “a” of the standard cell wall 21 is 90 μm, and the thickness “b” of the reinforced cell wall 22 is 117 μm. The radius of curvature of each R-angle part 231 is 0.25 mm. Other components of the honeycomb structure body of the second embodiment are the same of those of the first embodiment.

According to the configuration of the honeycomb structure body of the second embodiment, the presence of the R-angle parts 231 formed at the three interior angle parts 23 surrounding each of the reinforced intersections 241 can increase the strength of the reinforced cell walls 22. The strength reinforced area 5 composed of the reinforced cell walls 22 which are linked together can increase the strength thereof when compared with the area formed by the standard cell walls 21.

The other components of the honeycomb structure body of the second embodiment have the same action and effect of those of the honeycomb structure body of the first embodiment.

### Third Embodiment

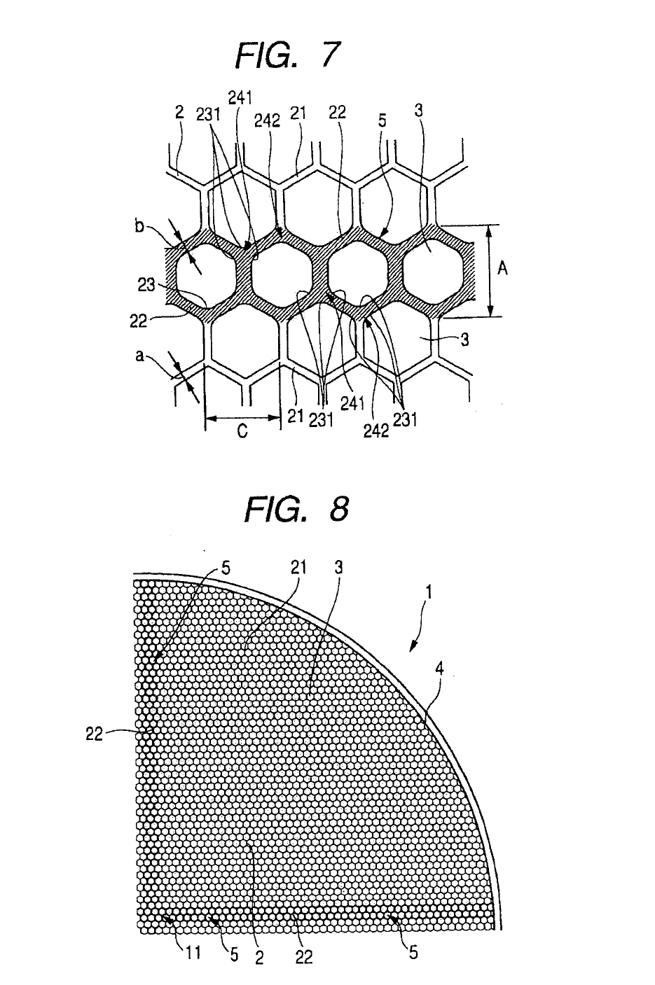

A description will now be given of the honeycomb structure body composed of the plural hexagonal cells according to the third embodiment of the present invention with reference to FIG. 7.

The configuration of the third embodiment further increases the strength of the reinforced cell walls 22 forming the strength reinforced area 5 when compared with the configurations of the first and second embodiments.

FIG. 7 shows a cross-section of the honeycomb structure body composed of the reinforced cell walls 22 and the standard cell walls 21 according to the third embodiment.

As shown in FIG. 7, the configuration of the honeycomb structure body according to the third embodiment has an additional R-angle part 231 formed at each of three interior angle parts 23 surrounding each of the boundary intersection 242 between the reinforced cell walls 22 and the standard cell wall 21 adjacent to each other in addition to the three interior angle parts 23 surrounding the reinforced intersection 241 between the adjacent reinforced cell walls 22.

In other words, with regard to one hexagonal cell 3 formed by surrounded with the reinforced cell walls 22, the one hexagonal cell 3 has six interior parts 23. In the six interior parts 23, four interior angle parts 23 formed at the reinforced intersections 241 between the reinforced cell walls 22 adjacent to each other and two interior angle parts 23 formed at the boundary intersections 242 between the reinforced cell walls 22 and the standard cell wall 21 adjacent to each other are R-angle parts 231 of an approximate circular shape. Namely, all of the six interior angle parts 23 are R-angle parts 231.

Other components of the honeycomb structure body of the third embodiment are the same of those of the second embodiment.

The configuration of the honeycomb structure body of the third embodiment can increase the strength of the reinforced cell walls 22 because of the formation of the R-angle parts 231 at the three interior angle parts 23 surrounding each reinforced intersection 241 and the two interior angle parts 23 surrounding each boundary intersection 242. The strength reinforced area 5 in the honeycomb structure body composed of the reinforced cell walls 22 linked together can be further increased when compared with the area where the standard cell walls 21 are placed.

The other components of the honeycomb structure body of the third embodiment have the same action and effect of those of the honeycomb structure body of the second embodiment.

### Fourth Embodiment

A description will be given of the honeycomb structure body composed of the plural hexagonal cells according to the fourth embodiment of the present invention with reference to FIG. 8 to FIG. 12. In particular, the fourth embodiment will disclose the strength reinforced area of another shape different from that of the strength reinforced area in the honeycomb structure body of the first embodiment.

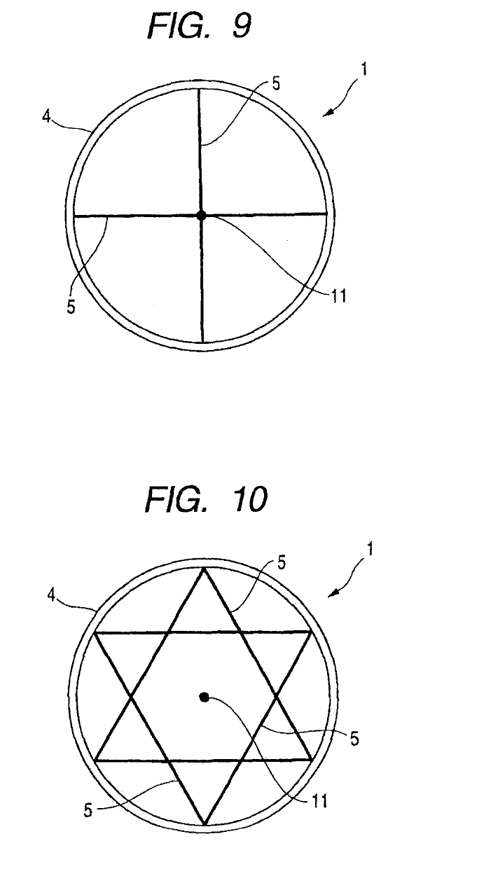

FIG. 8 is a cross-sectional view showing a part of the ceramic honeycomb structure body in the diameter direction according to the fourth embodiment of the present invention. In particular, FIG. 8 shows the strength reinforced area 5 placed through the center point 11 of the cross-section in the diameter direction of the honeycomb structure body. The strength reinforced area 5 shown in FIG. 8 and FIG. 9 is composed of two components that are orthogonal to each other at the center point 11 of the cross-section in the diameter direction of the honeycomb structure body.

FIG. 10 shows the strength reinforced area 5 of another shape composed of the reinforced cell walls in the honeycomb structure body according to the fourth embodiment. As shown in FIG. 10, the strength reinforced area 5 is composed of two triangle components. Three apexes of each triangle component are inscribed in the outer peripheral wall 4 of the honeycomb structure body. The two triangles forming the strength reinforced area 5 shown in FIG. 10 take a turn of 180 degrees to each other around the center point 11 of the cross section in the diameter direction of the honeycomb structure body.

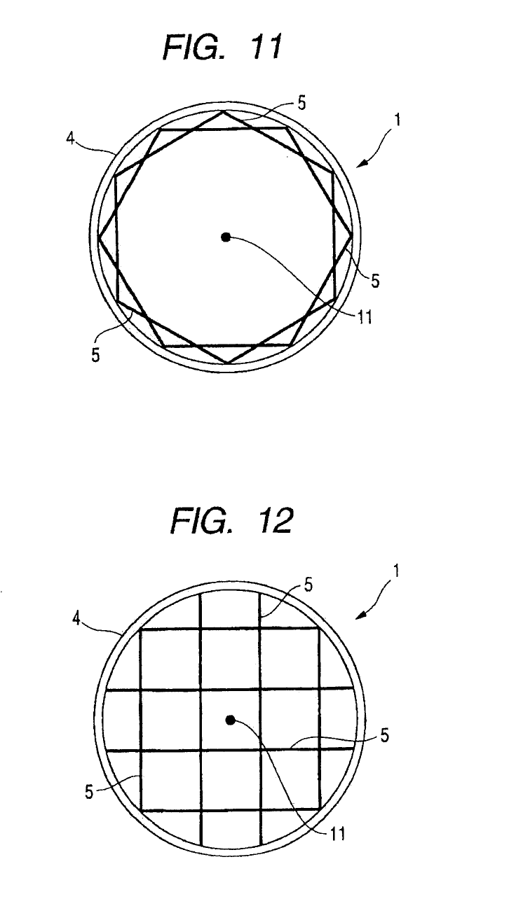

Still further, as shown in FIG. 11, the strength reinforced area 5 is composed of two components. Each component has a hexagon shape and the six apexes of each component of the hexagon shape are inscribed in the outer peripheral wall 4. The hexagon-shaped two components are shifted by 30 degree to each other around the center point 11 of the cross-section in the diameter direction.

Still further, as shown in FIG. 12, the strength reinforced area 5 is composed of plural straight-line shaped components. Some straight-line shaped components form a square-shaped component and the four corners thereof are inscribed in the outer peripheral wall 4. The components other than the square-shaped component in the strength reinforced area 5 are placed in a point-symmetry about the center point 11 of the cross-section in the diameter direction of the honeycomb structure body shown in FIG. 12.

In each of the configurations of the honeycomb structure body shown in FIG. 10, FIG. 11 and FIG. 12, the strength reinforced area 5 acts as the beams to the outer peripheral wall 4 of the honeycomb structure body. The presence of those beams is capable of adequately increasing the isostatic strength of the honeycomb structure body.

Other components of the honeycomb structure body of the fourth embodiment are the same of those of the first embodiment.

The configurations of the honeycomb structure body according to the fourth embodiments are the examples of the components that form the strength reinforced area 5. Because the concept of the present invention is not limited by those configurations described above, various configurations of the arrangement can be applied to the strength reinforced area in addition to a line shape, a triangle shape, a square shape and a hexagon shape.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

### INDUSTRIAL APPLICABILITY

The honeycomb structure body composed of a plurality of hexagonal cells of the present invention can be used for a exhaust gas purifying base material for internal combustion engines of automobiles or the like.

1. A honeycomb structure body comprising:
an outer peripheral wall covering an outer peripheral surface of the honeycomb structure body; and
a plurality of hexagonal cells formed inside the outer peripheral wall in a honeycomb structure configuration, each hexagonal cell being surrounded by cell walls placed in a hexagonal configuration,
wherein the cell walls forming the hexagonal cells are composed of standard cell walls and reinforced cell walls, a strength of the reinforced cell walls is stronger than that of the standard cell walls, and
the reinforced cell walls form a strength reinforced area of an approximate straight-line shape observed on a cross-section in a diameter direction of the honeycomb structure body, and both ends of the strength reinforced area are contacted to the outer peripheral wall.

2. The honeycomb structure body according to claim 1, wherein the strength reinforced area is composed of a plurality of components, and each component has an approximate straight-line shape.

3. The honeycomb structure body according to claim 2, wherein the components forming the strength reinforced area are placed in a point-symmetry around a center point of the cross section in the diameter direction of the honeycomb structure body.

4. The honeycomb structure body according to claim 2, wherein the components forming the strength reinforced area pass through the center point of the cross section in the diameter direction of the honeycomb structure body.

5. The honeycomb structure body according to claim 2, wherein at least some components forming the strength reinforced area form a polygon on the cross section in the diameter direction of the honeycomb structure body, and the polygon is inscribed in the outer peripheral wall.

6. The honeycomb structure body according to claim 1, wherein a thickness of each reinforced cell wall forming the strength reinforced area is larger than that of each standard cell wall.

7. The honeycomb structure body according to claim 6, wherein the thickness of each reinforced cell wall is within a range of 1.3 times to 1.8 times of the thickness of each standard cell wall.

8. The honeycomb structure body according to claim 1, wherein each hexagonal cell has six interior angle parts formed by the cell walls and three interior angle parts surrounding each of intersections between the reinforced cell walls adjacent to each other are R-angle parts of an approximate circular shape.

9. The honeycomb structure body according to claim 8, wherein three interior angle parts surrounding each of intersections between the reinforced cell walls and the standard cell wall adjacent to each other are R-angle parts of an approximate circular shape.

10. The honeycomb structure body according to claim 8, wherein the radius of curvature of the R-angle part is 0.15 mm to 0.4 mm.

11. The honeycomb structure body according to claim 9, wherein the radius of curvature of the R-angle part is 0.15 mm to 0.4 mm.

12. The honeycomb structure body according to claim 8, wherein the radius of curvature of the R-angle part is 0.2 mm to 0.35 mm.

13. The honeycomb structure body according to claim 9, wherein the radius of curvature of the R-angle part is 0.2 mm to 0.35 mm.

14. The honeycomb structure body according to claim 1, wherein a maximum width of the strength reinforced area is within a range of 1.0 mm to 5.0 mm.

15. The honeycomb structure body according to claim 1, wherein a thickness of the outer peripheral wall is within a range of 0.2 mm to 0.6 mm.

16. The honeycomb structure body according to claim 1, wherein a thickness of each standard cell wall is within a range of 50 μm to 125 μm.
